(19) United States
(12) Patent Application Publication
(10) Pub. No.: US 2025/0187165 A1
(43) Pub. Date: Jun. 12, 2025

(54) VIBRATION DAMPENING HAMMER

(71) Applicant: Robert Bosch GmbH, Stuttgart (DE)

(72) Inventor: Daniel Newkirk, Owatonna, MN (US)

(21) Appl. No.: 18/536,938

(22) Filed: Dec. 12, 2023

(51) Int. Cl. B25D 1/12

(52) U.S. Cl. CPC B25D 1/12

(57) ABSTRACT

A hammer having a handle and head, the head comprising a cavity encapsulating a slug. The slug is configured to move in at least one direction within the cavity upon impact of the hammer with a target, reducing the transfer of momentum into the handle of the hammer and thus reducing vibration of the hammer in a user's hand. This dampening of the vibration can improve user ergonomics by minimizing fatigue caused by vibrations during continued use of the hammer.

### TECHNICAL FIELD

This disclosure relates to shop tools, and in particular hand-operated tools.

### BACKGROUND

Modern hammers designed to be used by hand are comprised of a number of different materials and shapes. Conventional hammers utilize a solid head to strike a target most efficiently, but the impact of the strike creates a vibration in the hammer that can be fatiguing to the user while controlling the hammer. This fatigue is typically addressed by lessening the total weight of the hammer, but this solution reduces the efficiency of the hammer in striking a target. What is desired is a hammer that can lessen this vibration upon striking without reducing the total weight of the hammer.

### SUMMARY

One aspect of this disclosure is directed to a hammer having a handle extending in a first direction, and a head coupled to the handle. The head has at least an outer surface and an inner surface, the inner surface defining a cavity. The outer surface defines a first striking region configured to strike a target. The hammer additionally comprises a slug enclosed within the cavity, the slug having a smaller total volume that the volume of the cavity. The slug is configured to move in at least a second direction within the cavity. Some embodiments may additionally comprise a head with a sealing cap that defines at least a portion of the inner surface. The sealing cap may define one or more striking regions, such as a second striking region, suitable for striking a target. The slug may comprise a fluid channel that optimizes motion of the slug within the cavity in a given direction. The inner cavity may further comprise a fluid relief portion that is aligned with the fluid channel in at least one direction to optimize motion of the slug within the cavity.

The above aspects of this disclosure and other aspects will be explained in greater detail below with reference to the attached drawings.

### BRIEF DESCRIPTION OF THE DRAWINGS

FIG. 1 is an illustration of a hammer from a first perspective.

FIG. 2 is an illustration of the hammer from a second perspective.

FIG. 3 is a partially-exploded view of the hammer.

FIG. 4 is a cross-section of the head of a hammer having an internal slug.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

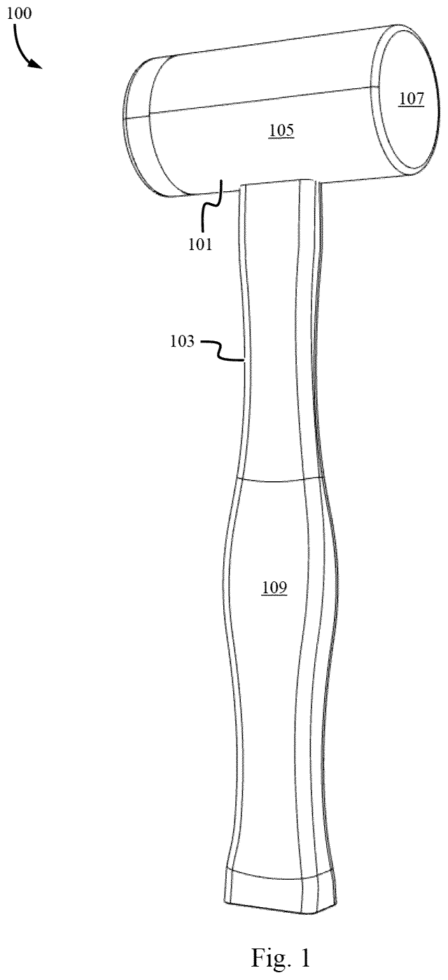

FIG. 1 illustrates a hammer 100 according to one embodiment of the invention disclosed herein. Hammer 100 comprises a head 101 and a handle 103 extending from the head in a first direction. The head 101 comprises an outer surface 105 that includes a first striking region 107 configured to strike a target. In the depicted embodiment, head 101 comprises a cylindrical shape and first striking region 107 encompasses a circular area, but other embodiments may comprise other configurations without deviating from the teachings disclosed herein. In the depicted embodiment, head 101 is comprised of a carbon steel alloy, but other embodiments may utilize another metal such as iron, titanium, aluminum, copper, or another type of steel alloy. In the depicted embodiment, head 101 is forged to optimize strength and resilience, to advantageously maximize the usable lifespan of hammer 100. In some embodiments, head 101 may be comprised of polymer or composite materials without deviating from the teachings disclosed herein.

In the depicted embodiment, handle 103 is comprised of a fiberglass composite material, but other embodiments may comprise other materials without deviating from the teachings disclosed herein. Other such embodiments may utilize steel, resin, wood, or other materials recognized to one of ordinary skill in the art. The handle 103 additionally comprises a grip portion 109, which is suitable to improve the friction of the handle 103 in a user's hand when swinging hammer 100. Grip portion 109 may be comprised of a materially providing greater tactile friction than the rest of hammer 100, such as rubber or another polymer. Alternatively, grip portion 109 may be comprised of the same material as the rest of handle 103, but feature a different texture better suited to increase the friction without deviating from the teachings disclosed herein. Some embodiments may not comprise an additional grip portion 109 without deviating from the teachings disclosed herein.

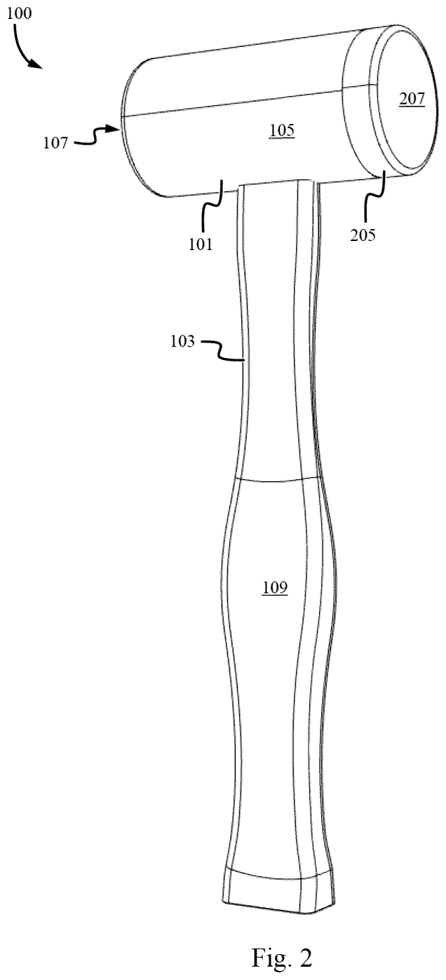

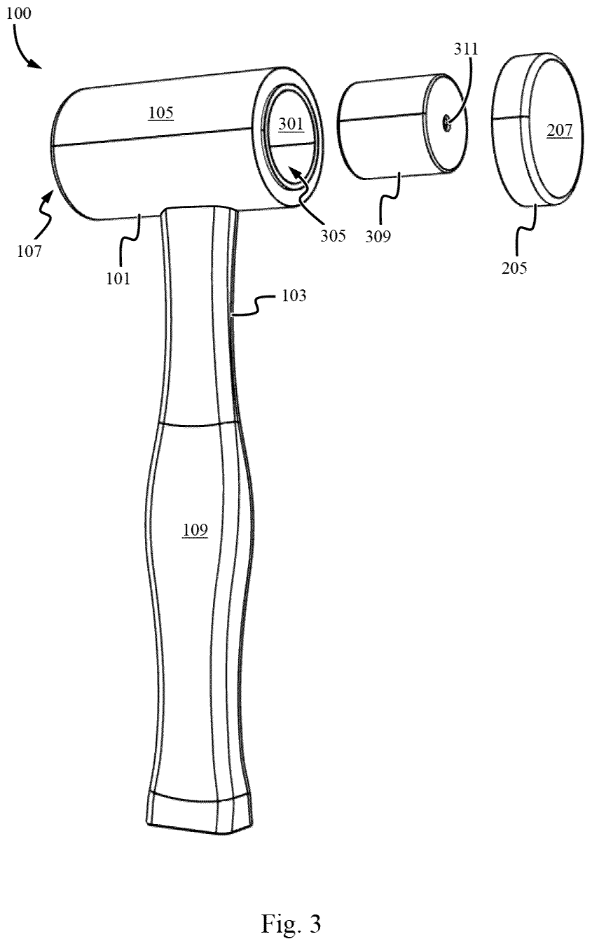

FIG. 2 is an illustration of hammer 100 from a different angle that illustrate additional features thereof. This perspective better shows that a component of the head 101 is a sealing cap 205, which itself comprises a portion thereof forming a second striking region 207. In the depicted embodiment, either first striking region 107 or second striking region 207 may be used to strike a target, but other embodiments may have different configurations supporting different utility. Sealing cap 205 is coupled with the rest of head 101 during the manufacturing process, and in the depicted embodiment is constructed of the same material as head 101. Other embodiments may have different configurations without deviating from the teachings disclosed herein. Additional features of sealing cap 205 are shown in FIG. 3.

FIG. 3 is a partially-exploded view of hammer 100, illustrating additional features thereof. In particular, sealing cap 207 is shown to provide an encapsulation of an inner surface 301 inside head 101. Inner surface 301 defines a cavity 305 within head 101. When hammer 100 is assembled, cavity 305 encapsulates a slug 309 within the head 101. Slug 309 moves freely within at least a one direction. In the depicted embodiment, slug 309 is suitable for moving within cavity 309 in an axis perpendicular to both the first striking region 107 and the second striking region 207. This freedom of motion permits slug 309 to provide a counter-active energy transfer when hammer 100 strikes an object, by receiving some of the reciprocal force of the impact with the target. This force is transferred into a momentum applied to slug 309 upon impact rather than head 101 or handle 103, and effectively creates a dampening effect on any vibrations experienced by the user upon impact. Advantageously, the mass of the slug 309 is encapsulated within head 101, and thus the total mass of head 101 includes the mass of slug 309 without losing efficacy for striking force. In the depicted embodiment, handle 103 extends in a direction perpendicular to the striking direction of head 101 to optimize ergonomic control of hammer 100, but other embodiments may comprise other configurations without deviating from the teachings disclosed herein.

In the depicted embodiment, both cavity 305 and slug 309 comprise cylindrical shapes, and slug 309 comprises a smaller volume than the total volume of cavity 305. This advantageously permits slug 309 to move in within cavity 305, optimizing transfer of the momentum into slug 309 upon impact. Other embodiments may comprise different shapes or sizes without deviating from the teachings disclosed herein. In the depicted embodiment, slug 309 comprises a fluid channel 311 which is intended to optimize movement of slug 309 within cavity 305. Fluid channel 311 permits the contents of cavity 305 to pass through slug 309 to minimize the chances that slug 309 is obstructed by any other contents of cavity 305. In the depicted embodiment, cavity 305 encapsulates air in addition to slug 309, but other embodiments may comprise other fluid materials without deviating from the teachings disclosed herein. In some embodiments, cavity 305 may be additionally filled with a liquid material having a greater viscosity than the viscosity of air to further dampen vibration of hammer 100 upon impact. In such embodiments, the fluid may comprise shock absorption fluid, such as conventional shock absorption fluid used in automotive and machine environments, without deviating from the teachings disclosed herein. In such embodiments, additionally added fluid material such be non-reactive to the inner surface 301 of cavity 305 to prevent short- or long-term corrosion of head 101.

In the depicted embodiment, sealing cap 205 comprises part of the enclosure for cavity 305. Security of this enclosure is essential for safe operation of hammer 100. In the depicted embodiment, sealing cap 205 is comprised of the same metal as the rest of head 101, and may be welded shut to optimize retention of the sealing cap 205 during use. Other embodiments—particularly those which utilize different materials for some or all components of hammer 100—may utilize a different coupling mechanism, such as screw threads, adhesives, or jambs, without deviating from the teachings disclosed herein.

The geometric dimensions and specification of hammer 100 may comprise a range of embodiments. In the depicted embodiment, slug 309 is a cylinder and fluid channel 311 runs between the circular bases of the cylinder at the center point of each respective base, other embodiments may comprise different configurations without deviating from the teachings disclosed herein. Slug 309 may comprise a different overall shape, fluid channel 311 may comprise a different route through slug 309, or the cross-sections of either may comprise a different shape without deviating from the teachings disclosed herein. In the depicted embodiment, the cross-section of both slug 309 and fluid channel 311 comprise a regular shape and dimension, but other embodiments may comprise other designs without deviating from the teachings disclosed herein. The volume and shapes of head 101, cavity 305, slug 309, and fluid channel 311 may be tuned to optimize the utility of hammer 100 for particular uses. Particular uses may defined by specific environments of use, specific target types, specific directions of impact, or any other utility of a hammer recognized by one of ordinary skill in the art without deviating from the teachings disclosed herein.

In the depicted embodiment, hammer 100 is optimized for singled-handed use. Such an embodiment features a handle length of 12-24 inches, but other embodiments may comprise other lengths without deviating from the teachings disclosed herein. The depicted embodiment features a head having a total weight of 2-10 pounds, but other embodiments may comprise other head weights without deviating from the teachings disclosed herein. The depicted embodiment features a slug weighing 0.4-2 pounds, but other embodiments may comprise other slug weights without deviating from the teachings disclosed herein. The depicted embodiment features at least one of the striking regions as having a diameter of 1.5-2.5 inches, but other embodiments may comprise other configurations without deviating from the teachings disclosed herein. By way of example, and not limitation, the depicted embodiment may comprise a handle 103 of 18 inches in length, a head 101 comprising a total of 5 pounds in weight, a slug 309 within head 101 comprising 1 pound in weight, and a first striking region 107 and a second striking region 207 each comprising a circular cross-section being 1.5 inches in diameter. Other embodiments may comprise other configurations without deviating from the teachings disclosed herein. In some such embodiments, hammer 100 may comprise more than one slug 309, such as a series of smaller slugs or a particle fill similar to sand, without deviating from the teachings disclosed herein.

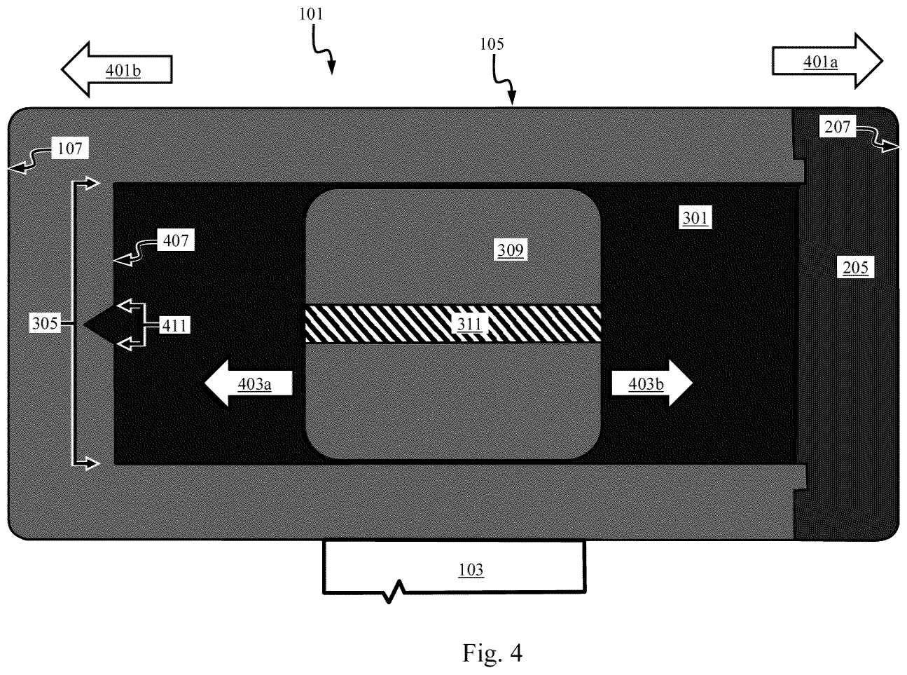

FIG. 4 is a cross-sectional illustration of head 101 when fully assembled and ready for use. Slug 309 is encapsulated within cavity 301 as defined by inner surface 305. FIG. 4 additionally illustrates the motion of slug 309 based upon a striking direction 401 with a reciprocal reactive direction 403. When hammer 100 is swung in a striking direction 401a, slug 309 will move in a reactive direction 403a upon impact, dissipating some of the momentum transfer into the handle 103. Conversely, when hammer 100 is swung in striking direction 401b, slug 309 will move in reactive direction 403b accordingly instead. The force moving the hammer in a striking direction 401 corresponds proportionally to the force exhibited to move slug 309 in its corresponding reactive direction 403. In the depicted embodiment, slug 309 is restricted to only moving along an axis defined by reactive directions 403, but other embodiments having other configurations may comprise other designs without deviating from the teachings disclosed herein.

In the depicted embodiment, it is additionally noted that a fixed region 407 of inner surface 301 comprises a fluid relief 411 aligned with fluid channel 311 of slug 309. Fluid relief 411 advantageously provides a space for excess fluid (including air) to escape into fluid channel 311 during motion of hammer 100. Fluid relief 411 advantageously prevents the creation of vacuum-like conditions within cavity 305 on either side of slug 309, which can impede motion of slug 309. In the depicted embodiment, only a single fluid relief 411 is shown, but other embodiments may comprise a different number of fluid reliefs 411 without deviating from the teachings disclosed herein. By way of example, and not limitation, an additional fluid relief may be present on the opposite portion of the inner surface (as part of sealing cap 205) without deviating from the teachings disclosed herein. Other embodiments may comprise no fluid relief without deviating from the teachings disclosed herein.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

1. A hammer comprising:
a handle extending in a first direction;
a head coupled to the handle, the head having at least an outer surface and an inner surface defining a cavity, the outer surface defining a first striking region configured to strike a target; and
a slug enclosed within the cavity, the slug having a volume smaller than the volume of the cavity and configured to move in at least a second direction.

2. The hammer of claim 1, wherein the head further comprises a sealing cap, the sealing cap defining a portion of the inner surface and further defining a second striking region of the outer surface, the second striking surface disposed opposite from the first striking region.

3. The hammer of claim 1, wherein a cross-section of the first striking region is a circle.

4. The hammer of claim 1, wherein a cross-section of the cavity has a perimeter in the shape of a circle having a first diameter, and a cross-section of the slug has a perimeter in the shape of a circle having a second diameter smaller than the first diameter.

5. The hammer of claim 1, wherein the slug is a cylinder, and wherein the slug further comprises a fluid channel defined between base surfaces of the cylinder.

6. The hammer of claim 5, wherein the inner surface comprises a fluid relief that is aligned with the fluid channel in at least one dimension.

7. The hammer of claim 1, wherein the volume of the cavity is filled with a fluid having a viscosity greater than the viscosity of air.

8. The hammer of claim 1, wherein the striking region measures between 1.5 to 2.5 inches at its widest point.

9. The hammer of claim 1, wherein the slug weighs between 0.4 to 2 pounds.

10. The hammer of claim 9, wherein the slug weighs 1 pound.
